(19) United States
(12) Patent Application Publication
(10) Pub. No.: US 2016/0171581 A1
(43) Pub. Date: Jun. 16, 2016

(54) APPARATUS AND METHOD FOR LOCATING PRODUCTS IN A RETAIL STORE USING A MOBILE DEVICE

(71) Applicant: Toshiba Global Commerce Solutions Holdings Corporation, Tokyo (JP)

(72) Inventors: Dean Frederick Herring, Youngsville, NC (US); Brad M. Johnson, Raleigh, NC (US); Jeffrey Smith, Raleigh, NC (US); Adrian Rodriguez, Durham, NC (US)

(21) Appl. No.: 14/566,896

(22) Filed: Dec. 11, 2014

(51) Int. Cl. G06Q 30/06; H04N 7/18

(52) U.S. Cl. CPC G06Q 30/0623; H04N 7/185

(57) ABSTRACT

A mobile device is configured to use metadata describing attributes of a packaged product to help the customer or sales associate locate the packaged product stored in inventory. The metadata may, for example, describe the size of the package, color of the package, product number, or placement of text and/or graphics on the package. In one embodiment, the user can use an image capture device on the mobile device to scan and capture images of packaged products stored in inventory. The mobile device uses the metadata to process the digital image and to detect the desired product in the captured image. The mobile device can output a modified image to a display that visually indicates the package product to the display of the mobile device. For example, the mobile device may highlight the packaged product in a digital image or add an icon to the digital image to indicate the packaged product. The modified digital image helps the customer distinguish the desired product from similar products and retrieve the desired product from inventory.

### TECHNICAL FIELD

The present disclosure relates generally to operation of retail stores and, more particularly to methods and apparatus for locating products within a retail store.

### BACKGROUND

Many retailers have a showroom for displaying products on sale and store the packaged products in a different location. In order to purchase a product, the customer finds a desired product on display in the showroom, records the product number for the desired product, and then finds the packaged product in inventory. Finding the correct product in inventory can be difficult for the customer. First, the customer may have no idea what the packaged product looks like making it difficult to locate the packaged product. Second, the business may have slightly different variations of the same product, which all have similar packaging. For example, the business may offer a product in multiple colors. In such case, there is a risk that the customer will not be able to differentiate the different products and will retrieve the wrong product from inventory.

### BRIEF DESCRIPTION OF THE DRAWINGS

FIG. 1 illustrates a customer in a display area of a retail store using a mobile device to scan a product code on a displayed product.

FIG. 2 illustrates a customer in a product storage area of a retail store using a mobile device to capture a digital image of packaged products stored in inventory.

FIG. 3 illustrates a digital image displayed on a display of the mobile device of packaged products stored in inventory with the desired product indicated by a graphic overlay.

FIG. 4 illustrates the main functional components of a mobile device for locating a desired product stored in inventory of a retail store.

FIG. 5 illustrates a general method of using a mobile device to locate products in a storage area of a retail store.

FIG. 6 illustrates a mobile device configured according to a first embodiment for locating a desired product using metadata obtained by scanning a product code.

FIG. 7 illustrates a mobile device configured according to a second embodiment for locating a desired product using a product ID obtained by scanning a product code.

FIG. 8 illustrates a mobile device configured according to a third embodiment for locating a desired product using a product image captured by an image capture device.

FIG. 9 illustrates a mobile device configured according to a fourth embodiment for locating a desired product using a product ID manually entered by a user.

FIG. 10 illustrates a computer program product for locating products in a storage area of a retail store.

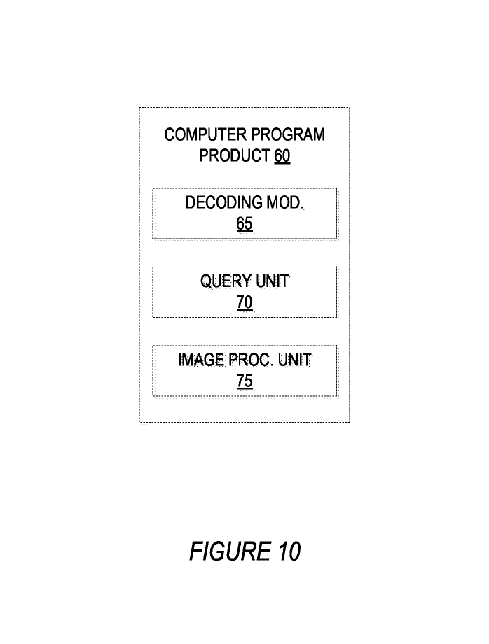

### DETAILED DESCRIPTION

Referring now to the drawings, exemplary embodiments of a mobile device 10 including an application for locating packaged products stored in inventory will be described. The mobile device 10, may, for example, comprise a smartphone, laptop computer, tablet, wearable computing device (e.g. GOOGLE GLASS®), or other mobile device with a display and imaging capabilities. The mobile device 10 may comprise a single housing unit containing all of the functional components of the mobile device 10. Alternatively, the mobile device 10 may comprise multiple housing units that collectively contain the functional components of the mobile device 10.

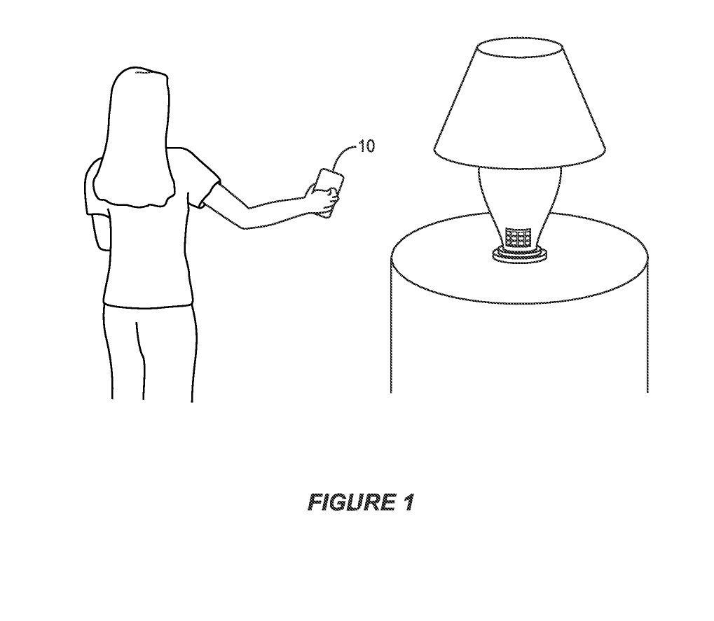

FIG. 1 illustrates a customer in a display area of a retail store. When a user sees a product displayed in a display area of the retail store, the user may, for example, use the mobile device 10 to scan a product code associated with the product on display. In the example shown in FIG. 1, the customer is using the mobile device 10 to scan a product code on a lamp. The product code may, for example, comprise a conventional bar code, 2D barcode (known as a tag bar code), 3D bar code, QR code, or other matrix bar code. In one embodiment, the product code includes metadata that identifies attributes or features of the packaged product, such as the size and color of the package, or the placement of text and graphics on the package, or geometric point features. Alternatively, the product code may include information, such as a product identifer (Product ID), that can be used to query a database to obtain the attributes or features of the packaged product.

In other embodiments, the mobile device 10 may employ radio frequency identification (RFID) or near field communication (NFC) to acquire information about the attributes or features of the displayed product. For example, an RFID or NFC tag may be placed on or near the displayed product in the showroom. The mobile device 10 may include a radio frequency (RF) tag reader to read the information stored in the RFID or NFC tag. The information, as previously described, may describe attributes or features of the product package for the displayed product, or a product ID that may be used to query a database to obtain the attributes or features of the displayed product.

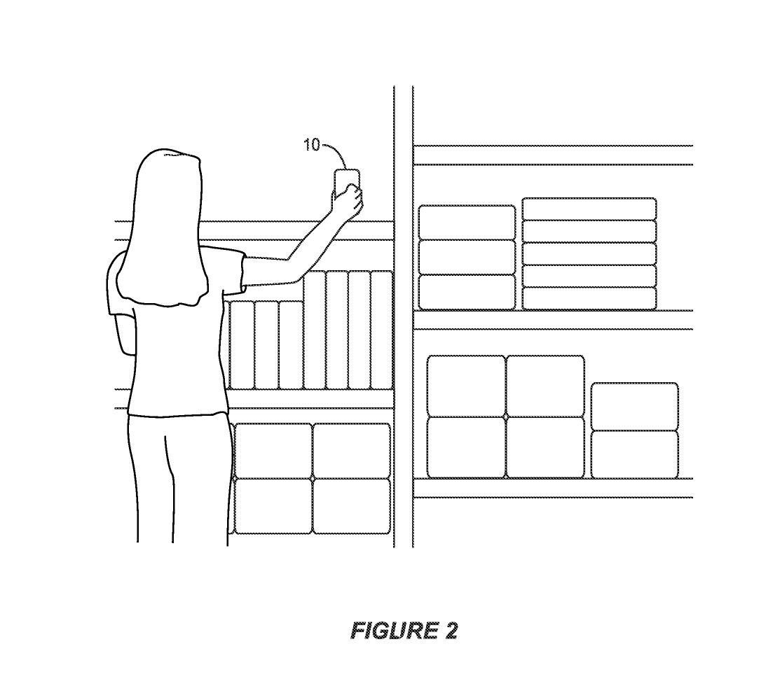

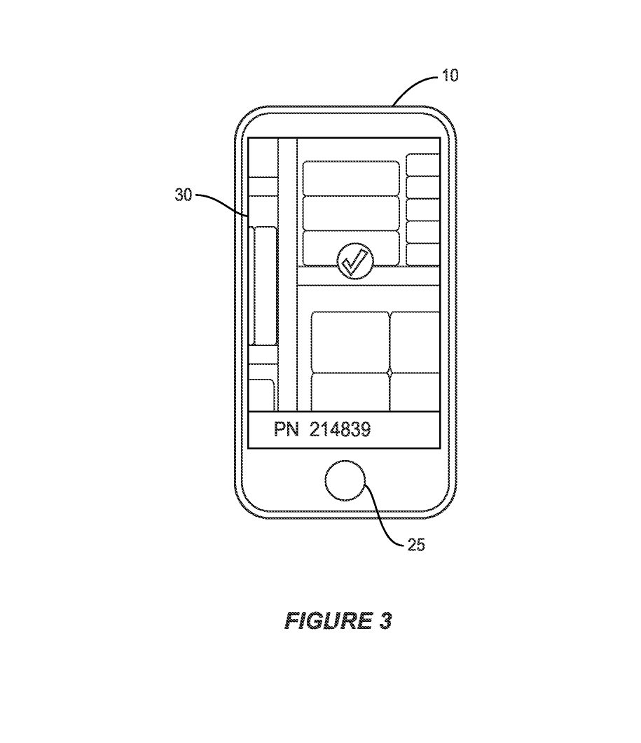

FIG. 2 illustrates the customer in a storage area of a retail store where products are stored in inventory. In some embodiments, the application on the mobile device 10 may display the location, for example, by specifying the aisle number and bay number where the product is stored in inventory. In other embodiment's, the application may provide the user a map of the store with the location of the product indicated on the map. Once the user arrives at the product storage area, the customer uses the camera or other image capture device on the mobile device 10 to scan the packaged products stored in inventory. The mobile device 10 processes the image of the packaged products in storage and uses the metadata previously acquired to recognize the desired product. The mobile device 10 outputs a digital image of the packaged products in inventory to the display of the mobile device 10 as shown in FIG. 3. The mobile device 10 may modify the digital image to visually indicate the desired product to the customer and to assist the customer in locating the item on the storage shelves. For example, the mobile device 10 may indicate the desired product highlighting the desired product in the digital image or overlaying a graphic of the desired product the digital image. In some embodiments, the application may also display a product number to allow the user to verify that the product highlighted is the desired product.

In other embodiments, the application may display a stored image of the product storage area where the packaged product is stored. When in the product storage area. the application may use the metadata to retrieve the stored image. The desired product may be highlighted in the image. The user may locate an item by visual comparison of the stored image with the product storage area. As previously noted, the application may also display a product number to allow the user to verify that the product retrieved is the desired product.

The mobile device 10 is particularly useful in retail stores having a separate showroom area for displaying products and a separate storage area for storing inventory. However, the mobile device 10 is also useful in retail stores where the products are displayed and stored in the same area.

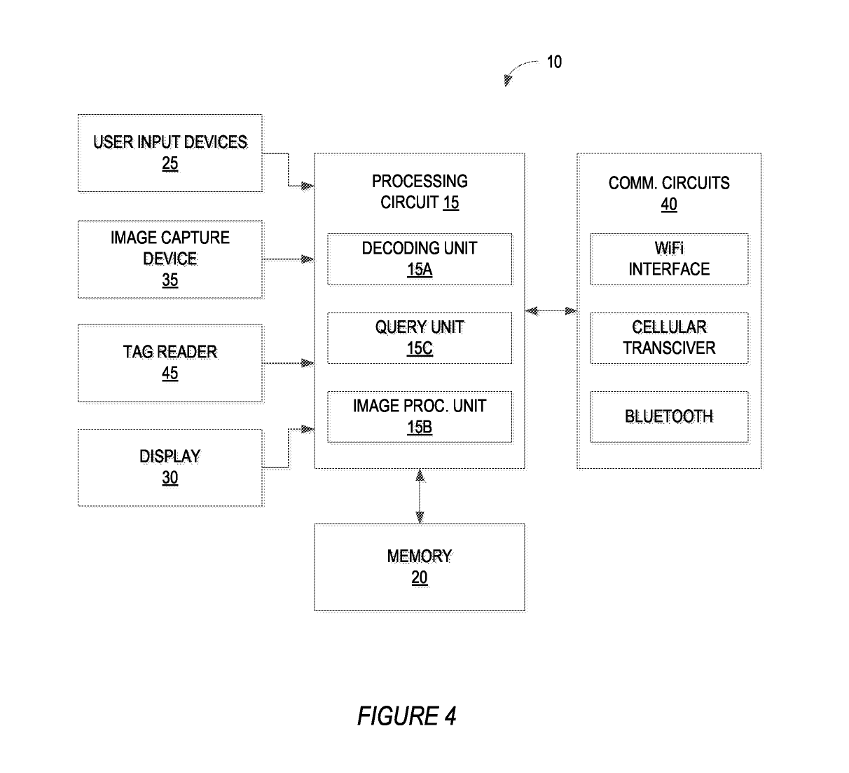

FIG. 4 illustrates the main functional components of an exemplary mobile device 10. The mobile device 10 comprises a processing circuit 15, memory 20, one or more user input devices 25, display 30, image capture device 35, and communication circuits 40. In some embodiments, the mobile device 10 may include a tag reader 45 for reading RFID tags and/or NFC tags. The mobile device 10 may comprise a self-contained unit or multiple units that are operatively connected by wired or wireless connections. For example, the processing circuit 15, memory 20 and communication circuit 40 may be housed in a base unit, while the user input devices 25, display 30 and image capture device 35 or housed in one or more remote units. The base unit and remote units may communicate via short-range radio links (e.g., Bluetooth® or WiFi).

The processing circuit 15 comprises one or more microprocessors, hardware circuits, firmware or a combination thereof. In the exemplary embodiments described herein, the processing circuit 15 comprises at least one of a decoding unit 15 A and query unit 15C, and an image processing unit 15B. The decoding unit 15A comprises a circuit configured to decode a product code, such as a bar code or QR code. The query unit 15C comprises a circuit configured to query a database to retrieve description information for a product package of a desired product. The image processing unit 15B comprises a circuit configured to 1) process digital images of packaged products stored in inventory to recognize a desired product, 2) modify the digital image to visually indicate the desired product, and 3) output the modified digital image to the display 30.

Memory 20 stores program code and data used by the processing circuit 15 for operation. Memory 20 includes both volatile and non-volatile memory. Memory 20 may comprise random access memory (RAM), read-only memory (ROM), electrically erasable programmable ROM (EEPROM) and/or flash memory. Memory 20 may comprise discrete memory devices, or may be integrated with one or more microprocessors in the processing circuit 15.

The user input devices 25 and display 30 provide a user interface enabling a user to interact with and control the mobile device 10. The user input devices 25 comprise any type of device for inputting data into a computing device. The user input devices may, for example, comprise keyboards, number pads, push buttons, touchpads, touchscreens or voice activated inputs. The display 30 comprises, for example, a liquid crystal display (LCD) or light emitting diode (LED) display. In some embodiments, the display 30 may comprise a touchscreen display that also functions as a user input device 25.

The image capture device 35 comprises a digital camera or image sensor, e.g. CCD sensor, for recording still images and/or video images. Images captured by the image capture device 35 are input to the processing circuit 15 for processing and storage as hereinafter described. As previously noted, the image capture device may be used to scan product codes on displayed products and to capture images of packaged products stored in inventory.

The communication circuit 40 comprises a transceiver circuit and/or interface circuit for communicating with remote devices over a communication network or direct communication link. For example, the communication circuit may comprise a WiFi interface, cellular radio interface, BLUETOOTH interface, Ethernet interface or other similar interface for communicating over a communication network or communication link. The mobile device 10 may use the communication circuit 40, for example, to communicate with a database server that stores attributes of the packaged products, or with a sales associate in the retail store.

In some embodiments, the user input devices 25, display 30 and/or image capture device 35 may be housed in a remote unit that communicates via a wired or wireless link with a base unit containing the processing circuit 15 and memory 20. In this case, the remote unit and base unit may communicate, for example, via BLUETOOTH® or other short-range radio interface.

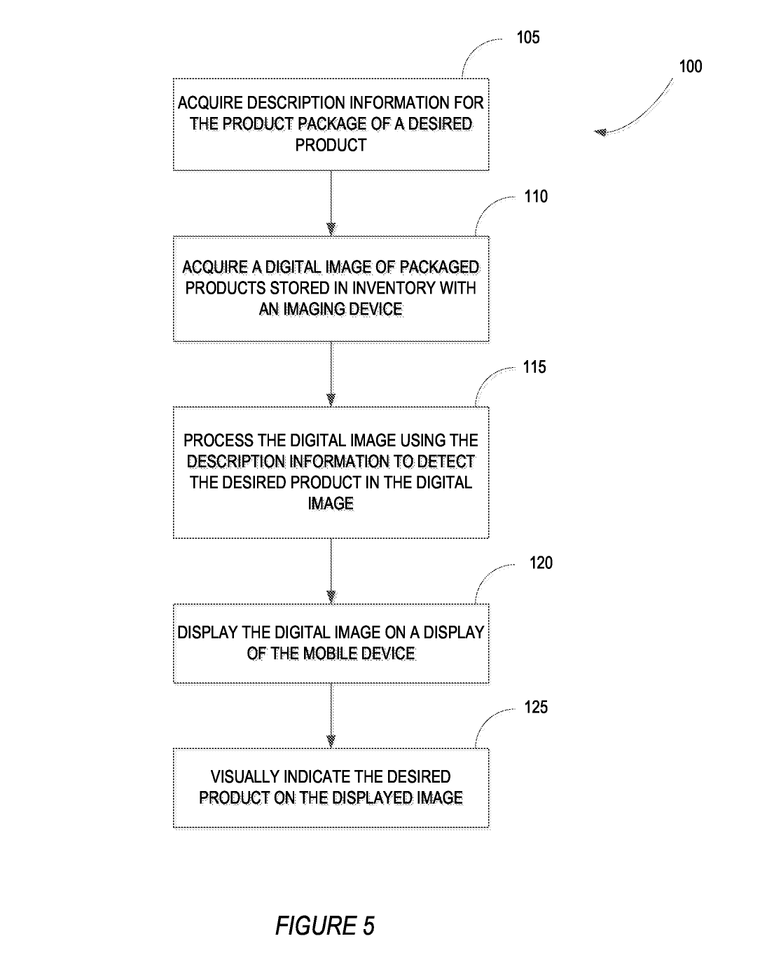

FIG. 5 illustrates an exemplary method 100 implemented by a mobile device 10 of locating a desired product stored in inventory of a retail store. When the customer is in the display area of a retail store, the customer uses the mobile device 10 to acquire description information for a desired product (block 105). The description information describes one or more attributes or features of a product package for the desired product. In some embodiments, the attributes or features of the product package are encoded as metadata in a product code, such as a bar code or QR code. The customer uses the mobile device 10 to scan the product code and extract the attributes of the product package. In other embodiments, the attributes of the product package are acquired by using a product ID to query a database that stores the attributes of the desired product. The product ID may be encoded in a product code or manually entered by the user. In other embodiments, the customer may use an image capture device 35 on the mobile device 10 to capture an image of the displayed product. The image of the displayed product may be sent to a server that is configured to recognize the product in the image and return the attributes of the product package to the mobile device 10.

Referring back to FIG. 5, in the product storage area of a retail store, the customer acquires a digital image of packaged products stored in inventory with an image capture device (block 110). The digital image may comprise a still image or video image. The application may prompt to move away from or closer to the packaged products while capturing the image to make sure that all salient features are captured in the image. In some embodiments, the application may prompt the user to move to a different location, for example, if it is detected that the user is not in the correct location.

The mobile device 10 processes the digital image of the packaged products using the description information previously acquired to detect the desired product in the digital image (block 115). To help the customer locate the desired product, the mobile device 10 displays the digital image of the packaged products on a display of the mobile device (block 120) and visually indicates the desired product on the display image (block 125). For example, the mobile device 10 may modify the digital image prior to displaying it to highlight the desired product, or to add graphics or text to the displayed image. The mobile device 10 may also indicate similar items to specifically stay away from.

The mobile device 10 may use any known product recognition algorithm to recognize the packaged product. The particular algorithm used is not a material aspect of the disclosure.

As one example, U.S. Pat. No. 8,494,909 entitled “Automatic Learning In a Merchandise Checkout With Visual Recognition” and U.S. Pat. No. 8,196,822 entitled “Self Checkout With Visual Recognition,” which are incorporated herein by reference, describe a method of product recognition based on recognition of scale invariant features of the product package. To briefly summarize, the image processing unit 15C extracts geometric point features that are preferably invariant to a range of image transformations, such as translation, rotation, and scaling from the captured image of the packaged products. The extracted point features for each packaged product in the captured image are then compared to corresponding features described by the description information. In one embodiment, a Scale Invariant Feature Transform (SIFT) descriptor for the extracted features is determined that describes the local appearance at each point feature. The SIFT descriptor is then compared to local descriptors provided by the description information and a match is determined based on the Euclidean distance in the feature space, such as the 128 dimensional SIFT space.

In another embodiment, Optical Character Recognition (OCR) techniques may be used to extract text from labels applied to product packages. The extracted text may be compared to text provided by the description information to determine a match. Similar techniques may be used to identify color or graphics printed on package labels.

OCR-based recognition may be used in combination with product recognition based on geometric point features. For example, SIFT-based product recognition in some instances may return two or more close matches. This situation may occur, for example, where two product packages are nearly identical with the only difference being slight changes in text printed the package or labels. In this situation, OCR-based recognition may be employed to discriminate between similar product packages with small variations in labels.

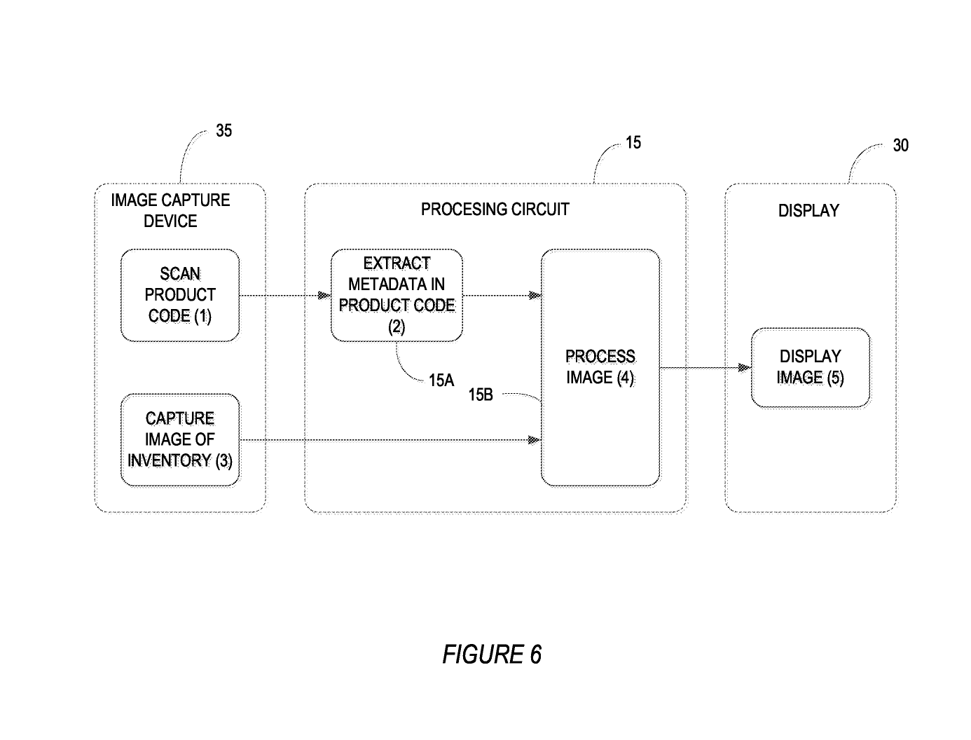

FIG. 6 illustrates a first exemplary configuration of a mobile device 10 for locating a desired product in a storage area of a retail store using the mobile device 10. In this embodiment, the mobile device 10 is used in an offline mode to help a user locate the packaged product in inventory. When the customer is in the product display area of the retail store, the customer uses the image capture device 35 to scan a product code associated with the displayed product (step 1). It is assumed that the attributes of the product package for the desired product are encoded into the product code as metadata. The product code is input to the processing circuit 15. A decoding unit 15A in the processing circuit 15 processes the product code to extract the metadata from the product code (step 2). The metadata in this embodiment describes attributes of the package product, such as the package size, color, or placement of text and graphics on the package. The attributes are provided by the decoding unit 15A to the image processing unit 15B.

In the product storage area, the customer uses the image capture device 35 to capture a digital image of the packaged products stored in inventory (step 3). For example, the user may scan the products stored in inventory with the image capture device 35 to capture a video image. Alternatively, the user may capture a still image. The digital image of the packaged products is input to the processing circuit 15. An image processing unit 15B in the processing circuit 15 processes the digital image and uses the metadata extracted from the product code to identify the desired product (step 4). After the desired product in the digital image is identified, the processing circuit 15 generates an output image in which the desired product is visually indicated by highlighting or graphic overlay. The modified digital image with highlighting of graphic overlays is output to the display 30 for display to the user (step 5).

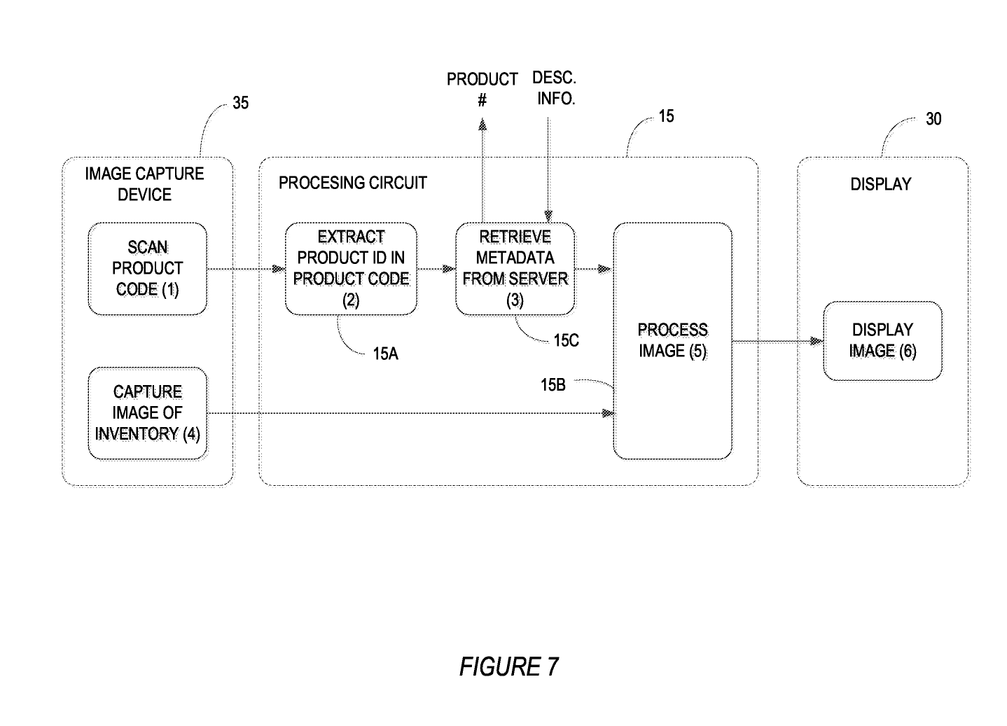

FIG. 7 illustrates a second exemplary configuration of a mobile device 10 for locating a desired product in a storage area of a retail store using the mobile device 10. In this embodiment, the mobile device 10 is used in an online mode to help a user locate the packaged product in inventory. When the customer is in the product display area of the retail store, the customer uses the image capture device 35 to scan a product code associated with the displayed product (step 1). It is assumed that a product ID for the desired product is encoded into the product code as metadata. The product code is input to the processing circuit 15. A decoding unit 15A in the processing circuit 15 processes the product code to extract the product ID from the product code (step 2). After extracting the product ID, a query unit 15C in the processing circuit 15 uses the product ID to query a database server to obtain the attributes of the product package for the desired product (step 3). The query unit 15C communicates via the communication circuit 40 with the database server. The database server may be operated by the retail store, or by a third party. In one embodiment, the query unit 15C sends the product ID to the database server. The database server performs a product lookup using the product ID and returns the attributes of the product package for the desired product to the query unit 15C. The attributes are provided by the query unit 15C to the image processing unit 15B.

In the product storage area, the customer uses the image capture device to capture a digital image of the packaged products stored in inventory (step 4). For example, the user may scan the products stored in inventory with the image capture device 35 to capture a video image. Alternatively, the user may capture a still image. The digital image of the packaged products is input to the processing circuit 15. The processing circuit 15 processes the digital image and uses the attributes obtained from the database server to identify the desired product (step 5). After the desired product in the digital image is identified, the image processing unit 15B in the processing circuit 15 generates an output image in which the desired product is visually indicated by highlighting or graphic overlay. The modified digital image with highlighting of graphic overlays is output to the display 30 for display to the user (step 6).

A variation of the embodiment shown in FIG. 7 may be used in an offline mode to help a customer locate a desired product stored in inventory. More particularly, a product database containing the attributes of the product package may be stored in memory 30 of the mobile device 10. In this embodiment, the query unit 15C may be configured to use the product ID obtained by decoding the product code to lookup the attributes of the desired product in the product database. The customer may download the product data from a website operated by the retail store, or by a third party.

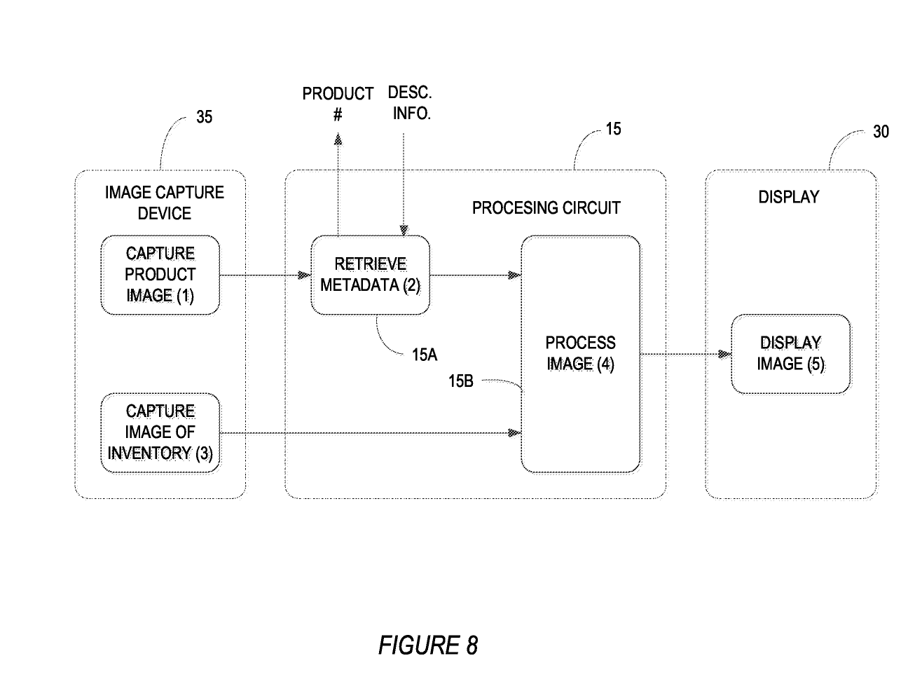

FIG. 8 illustrates a third exemplary configuration of a mobile device 10 for locating a desired product in a storage area of a retail store using the mobile device 10. In this embodiment, the mobile device 10 is used in an online mode to help a user locate the packaged product in inventory. When the customer is in the product display area of the retail store, the customer uses the image capture device 35 to capture an image of the displayed product (step 1). The product image is input to the processing circuit 15. A query unit 15C in the processing circuit 15 uses the product image to query a database server to obtain the attributes of the product package for the desired product. The query unit 15C communicates via the communication circuit 40 with the database server (step 2). The database server may be operated by the retail store, or by a third party. In one embodiment, the query unit 15C sends the product image to the database server. The database server processes the product image to identify the product, performs a product lookup using a product ID to retrieve the product attributes, and returns the attributes of the product package for the desired product to the query unit 15C. The attributes are provided by the query unit 15C to the image processing unit 15B.

In the product storage area, the customer uses the image capture device to capture a digital image of the packaged products stored in inventory (step 3). For example, the user may scan the products stored in inventory with the image capture device 35 to capture a video image. Alternatively, the user may capture a still image. The digital image of the packaged products is input to the processing circuit 15. The image processing unit 15B in the processing circuit 15 processes the digital image and uses the attributes obtained from the database server to identify the desired product (step 4). After the desired product in the digital image is identified, the image processing unit 15B in the processing circuit 15 generates an output image in which the desired product is visually indicated by highlighting or graphic overlay. The modified digital image with highlighting of graphic overlays is output to the display 30 for display to the user (step 5). In some embodiments, the output image may be streamed from a base unit in which the image processing is performed to a remote unit that displays the output image on a display. For example, the image processing may be performed in a smart phone that serves as a base unit and the output image may be sent to a wearable device (e.g., GOOGLE GLASS®) that includes a heads up display.

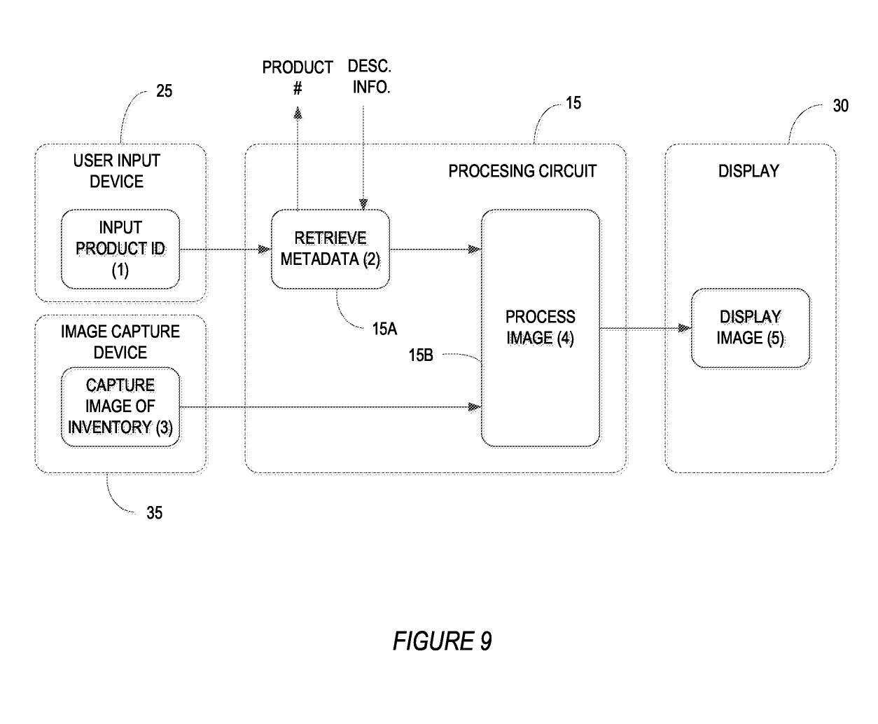

FIG. 9 illustrates a fourth exemplary configuration of a mobile device 10 for locating a desired product in a storage area of a retail store using the mobile device 10. In this embodiment, the mobile device 10 is used in an online mode to help a user locate the packaged product in inventory. When the customer is in the product display area of the retail store, the customer enters the product code using a user input device, e.g. keypad or virtual keypad on a touchscreen (step 1). It is assumed that a product ID for the desired product is encoded into the product code as metadata. The product code is input to the processing circuit 15. A query unit 15C in the processing circuit 15 uses the product ID to query a database server to obtain the attributes of the product package for the desired product (step 2). The query unit 15C communicates via the communication circuit 40 with the database server. The database server may be operated by the retail store, or by a third party. In one embodiment, the query unit 15C sends the product ID to the database server. The database server performs a product lookup using the product ID and returns the attributes of the product package for the desired product to the query unit 15C. The attributes are provided by the query unit 15C to the image processing unit 15B.

In the product storage area, the customer uses the image capture device to capture a digital image of the packaged products stored in inventory (step 3). For example, the user may scan the products stored in inventory with the image capture device 35 to capture a video image. Alternatively, the user may capture a still image. The digital image of the packaged products is input to the processing circuit 15. The processing circuit 15 processes the digital image and uses the attributes obtained from the database server to identify the desired product (step 4). After the desired product in the digital image is identified, the image processing unit 15B in the processing circuit 15 generates an output image in which the desired product is visually indicated by highlighting or graphic overlay. The modified digital image with highlighting of graphic overlays is output to the display 30 for display to the user (step 5).

A variation of the embodiments shown in FIGS. 7 & 9 may be used in an offline mode to help a customer locate a desired product stored in inventory. More particularly, a product database containing the attributes of the product package may be stored in memory 30 of the mobile device 10. In this embodiment, the query unit 15C may be configured to use the product ID input by the user to lookup the attributes of the desired product in the product database. The customer may download the product data from a website operated by the retail store, or by a third party.

Another aspect of the disclosure comprises a computer program product 60 including program code for helping a customer in a retail store locate a packaged product in inventory. The computer program product 60 may, for example, be embodied in a non-transitory, computer-readable medium, such as the memory of a mobile device 10, or a removable memory device, e.g. thumb drive or disc. The computer program product 60 comprises at least one of a decoding module 65 and query module 70, and an image processing module 75. The decoding module 65 comprises program code that when executed by the processing circuit 15 in mobile device 10 causes the processing circuit 15 to decode product codes input from an image capture device 35. In some embodiments, the decoding module 65 decodes the product code to directly acquire the attributes of the product package for the desired product as metadata. In other embodiments, the decoding module 65 decodes the product code to obtain a product ID that is used by the query module 70 as hereinafter described.

The query module 70 comprises computer program code that when executed by the processing circuit 15 and mobile device 10 causes the processing circuit to query a database using the product ID of a desired product to obtain the attributes of the product package for the desired product. In some embodiments, the query module 70 includes program codes for communicating via a communication circuit 40 with a remote database server. In other embodiments, the query module 70 includes program code for querying a database stored in internal memory 30 of the mobile device 10.

The image processing module 75 comprises computer program code that when executed by the processing circuit 15 in the mobile device 10 causes the processing circuit 15 to process a digital image of packaged products stored in inventory using description information to detect the desired product in the digital image. The image processing module 75 further comprises program code executed by the processing circuit 15 for modifying the digital image to visually indicate the desired product in the digital image, and for displaying the modified digital image on the display 30 of the mobile device 10.

What is claimed is:

1. A method implemented in a mobile device of locating a desired product in a product storage area of a retail store, said method comprising:
acquiring description information for a desired product, said description information describing one or more attributes of a product package for the desired product;
acquiring, at the product storage location, a digital image of packaged products stored in inventory with an image capture device;
processing the digital image using the description information to detect the desired product in the digital image;
displaying the digital image on a display of the mobile device; and
visually indicating the desired product on the displayed image.

2. The method of claim 1 wherein acquiring description information for the desired product comprises:
capturing an image of a product code containing the description information;
decoding the product code to extract the description information.

3. The method of claim 1 wherein acquiring description information for the desired product comprises:
acquiring a product identifier for the desired product;
sending a request for the description information to a database server, said request including the product identifer; and
receiving, responsive to the request, the description information from the database server.

4. The method of claim 1 wherein acquiring description information for the desired product comprises:
capturing a product image of the desired product with an image capture device;
sending a request for the description information to a database server, said request including the product image; and
receiving, responsive to the request, the description information from the database server.

5. The method of claim 1 wherein acquiring description information for the desired product comprises reading the description information from a radio frequency tag.

6. The method of claim 1 wherein acquiring a digital image of products stored in inventory with an image capture device on the mobile device comprises capturing a digital video of the products stored in inventory while a user scans the products stored in inventory with the image capture device.

7. The method of claim 1 wherein processing the digital image using the description information to detect the desired product comprises processing the digital image with an image processing circuit configured to recognize the product package for the desired product based on the description information.

8. The method of claim 1 wherein visually indicating the desired product on the displayed image comprises highlighting the desired product in the displayed image.

9. The method of claim 1 wherein visually indicating the desired product on the displayed image comprises overlaying an icon on the digital image to indicate the desired product in the displayed image.

10. A mobile device for locating a desired product stored in a product storage location of a retail store, said mobile device comprising:
an image capture device;
an electronic display;
a processing circuit operatively connected to the image capture device and the display, said processing circuit configured to:
acquire description information for a desired product, said description information describing one or more attributes of a product package for the desired product;
acquire, at the product storage location, a digital image of packaged products stored in inventory from the image capture device;
process the digital image using the description information to detect the desired product in the digital image;
output the digital image to the display; and
visually indicate the desired product on the displayed image.

11. The mobile device of claim 10 wherein, to acquire description information for a desired product, the processing circuit is configured to:
capture an image of a product code containing the description information;
decode the product code containing the description information.

12. The mobile device of claim 10 wherein, to acquire description information for a desired product, the processing circuit is configured to:
acquire a product identifier for the desired product;
send a request for the description information to a database server, said request including the product identifer; and
receive, responsive to the request, the description information from the database server.

13. The mobile device of claim 10 wherein, to acquire description information for a desired product, the processing circuit is configured to:
capture a product image of the desired product with an image capture device on the mobile device;
send a request for the description information to a database server, said request including the product image; and
receive, responsive to the request, the description information from the database server.

14. The mobile device of claim 10 wherein, to acquire description information for a desired product, the processing circuit is configured to read the description information from a radio frequency tag.

15. The mobile device of claim 10 wherein, acquire a digital image of packaged products stored in inventory, the processing circuit is configured to receive a digital video of the products stored in inventory captured by the image capture device while the user scans the packaged products stored in inventory.

16. The mobile device of claim 10 wherein the processing circuit includes an image processing circuit configured to recognize the product package for the desired product based on the description information.

17. The mobile device of claim 9 wherein, to visually indicate the desired product on the displayed image, the processing circuit is configured to highlight the desired product in the displayed image.

18. The mobile method of claim 1 wherein, to visually indicate the desired product on the displayed image, the processing circuit is configured to overlay an icon on the digital image.

19. A non-transitory computer readable medium containing executable program code that, which executed by a processing circuit in a mobile device, causes the mobile device to:
acquire description information for a desired product, said description information describing one or more attributes of a product package for the desired product;
acquire, at a product storage location, a digital image of packaged products stored in inventory from an image capture device on the mobile device;
process the digital image using the description information to detect the desired product in the digital image;
output the digital image to a display on the mobile device; and
visually indicate the desired product on the displayed image.

20. The computer readable medium of claim 19 wherein, to acquire description information for a desired product, the program code causes the mobile device to decode a product code containing the description information.
